(19) United States
(12) Patent Application Publication
(10) Pub. No.: US 2007/0009854 A1
(43) Pub. Date: Jan. 11, 2007

(54) Dental or medical implants and method therefor

(75) Inventor: Vincent J. Morgan, Boston, MA (US)

Correspondence Address: John A. Haug, P.O. Box 386, West Harwich, MA, 02671, US

(73) Assignee: DEBBIE, LLC

(21) Appl. No.: 11/479,168

(22) Filed: Jul. 1, 2006

Related U.S. Application Data
(60) Provisional application No. 60/696,688, filed on Jul. 5, 2005.

(51) Int. Cl. A61C 8/00

(52) U.S. Cl. 433/173

(57) ABSTRACT

A screw type implant is formed with only enough thread turns to provide for initial stability and an unthreaded length of the implant has a diameter less than that of the osteotomy in which the implant is to be received by an amount, 200 microns or more, sufficient to allow the formation of haversian-type bone. According to one embodiment the unthreaded length is located at the apical end of the body while in a second embodiment the unthreaded length is located centrally on the body. Another embodiment has a helical groove extending along the unthreaded length and formed with a depth sufficient to allow for the formation of haversian-type bone even when the implant body is not centrally aligned along its length within the osteotomy. Another embodiment shows an ultra short platform type implant that is provided with an annular groove formed in its apical end face for increasing the implant's lateral load receiving capability.

### CROSS REFERENCES TO RELATED APPLICATIONS

Provisional application No. 60/696,688, filed on Jul. 5, 2005 and copending application Ser. No. 10/736,051, filed on Dec. 15, 2003.

### FIELD OF THE INVENTION

This invention relates generally to implants for placement into an osteotomy in the bone of a living being and more particularly to dental implants and methods for supporting haversian-type bone growth between the implants and the surfaces defining the osteotomies.

### BACKGROUND OF THE INVENTION

Implants formed of biocompatible material such as titanium alloys, and often provided with an HA (calcium phosphate) coating to promote osseointegration, are placed into respective osteotomies and allowed to heal with the objective to allow bone to fill in open spaces between the implants and the bone in order to securely grasp the implants.

The new bone that forms can be a dense bone eventually healing into cortical-type bone with a haversian-type anatomy. This type of bone is capable of acting as though it were part of the actual implant.

The new bone can also form a weaker, less dense structure with no blood vessel development through appositional growth. This type of bone does not have the desired strength for optimal functional performance with implants, particularly short implants.

Investigations have shown that bone ingrowth/ongrowth for porous and/or featured metallic and ceramic biocompatible materials depend on the physical sizes and shapes of the various surface dimensions. In general, cross sectional dimensions of openings greater than 100 micrometers, when implants are placed in functional bone, have shown space enough for blood vessel development (vascular pathways) and bone modeling plus remodeling processes leading to haversian-type microstructures. This process has been described for conditions of controlled force transfers and limited micromotions along the implant-to-bone interfaces during the healing period. Increased surface opening dimensions (e.g., 100-1000 micrometers) have shown increased rates of bone filing (growth) and maturation. However, implant cross section and depth sizes are often limited by implant size which must often be specific to the host bone anatomy and the basic strength properties of the implant. For example, alveolar bone cross sections (widths) for dental edentulous regions are often limited to 6-8 mm (6000-8000 micrometers) or less and the solid central sections of implants must withstand functional loading without breaking.

Considerations of endosteal dental implant design (size and geometry of the body section) compared to the size and shape of the surgical osteotomy for implant placement have shown that the implant “fit and fill” are critical to the type of bone along the implant interface, kinetics of healing and longer term clinical outcomes.

Plateau and screw-types of dental implant designs have been utilized for oral reconstruction for more than three decades. Over this period much has been learned about the kinetics of healing and interfacial contact (osseointegration) between synthetic biomaterials and functional bone.

The plateau design dental implants are placed into bone osteotomies (drill holes) where the perimeter of the implant plateaus contact the prepared surface of the osteotomy. This condition provides stabilization for bone healing and a space for vascularization, formation of new callus and subsequent haversian-type bone to support functional (intraoral) loading along the bone-to-implant interface. This process represents a known sequence of normal bone healing, i.e., formation of a blood clot, vascularization, callus formation as modeling and subsequent bone remodeling. Dynamic rates of callus formation (space filling and stabilization) have been shown to be in the range of 10-50 micrometers per day. Studies of bone healing and maturation (remodeling) into the body sections of plateau-type dental implant designs have also shown unique adaptation to the implant. This adaptation of bone between the implant plateaus is a semi and full-circular shape and microstructure, including a centrally located vascular region within the bone. This bone, at maturity, demonstrates a haversian-type anatomy.

In contrast to the description above, screw, cylinder and plate-type dental implant designs are normally placed into an osteotomy that fits the shape and size of the implant (often an interference fit). Fitting of matched geometries between the implant body and the osteotomy leads to a narrow gap (or contact) between the implant surface and the bone. Therefore, bone healing for this design and placement is normally appositional ongrowth, where the bone fills any open regions with growth from the osteotomy surfaces (residual bone) towards the implant surface. Normal rates of appositional bone growth have been reported as 1-3 micrometers per day, however, where bone is under pressure and before there can be any deposition of bone by ostoblastic activity, removal of bone by osteoclastic activity occurs. Histological studies have shown that appositional bone growth under these conditions leads to a bony anatomy where the new bone takes on the microstructural characteristics of the pre-existing bone region.

### SUMMARY OF THE INVENTION

It is an object of the invention to provide apparatus and methods for forming cortical-type bone structure around a dental implant. Another object of the invention is to provide for anatomical bony environment of the type that allow the secure placement of short dental implants, such as those having a ratio of length to width of 1.5:1 or less. Yet another object of the invention is the provision of dental implants, particularly screw-type and short implants, which allow for the contiguous formation of blood clots to enable the development of bone that can act as an extension of the implant.

Briefly, in accordance with a preferred embodiment of the invention, a screw-type implant is formed with only sufficient number of threads to provide for initial stability and an unthreaded length of the implant is provided that has a diameter less than that of the osteotomy in which the implant is received by an amount sufficient to allow for the formation of a blood clot, preferably forming a space 100 micrometers or more in cross section. According to one preferred embodiment, the apical portion is without threads and has a smaller diameter than the prepared osteotomy as well as the middle and coronal portions of the implant. As noted above, the middle portion of the implant has only a minimum number of threads, i.e., two to six threads and preferably, three or four. These threads are wider than the diameter of the osteotomy by an amount only to the extent necessary to achieve initial stability until the faster bone healing around the apical portion can provide stability. Their wider diameter provides for initial stability by compressing the bone, which will result in a different type of bone healing than that of the apical portion of the implant where there is no compression of the bone. The smaller number of threads relative to the length of the implant than conventional screw-type implants facilitates insertion into the prepared osteotomy since fewer rotations are required to fully seat the implant. The fewer turns will also minimize the trauma to the bone at the orifice of the osteotomy since it will be burnished less than an implant with more threads. The implant can have a variety of prosthetic head portions, shouldered, non-shouldered, o-ring ball type, screw or cement type, frictional telescopic type. The implant can be a single or multiple piece structure and can be used for immediate or delayed function in permanent or transitional applications for prosthetic replacement or retention as well as for orthodontic or distraction osteogenic purposes and can be made of titanium or another suitable biocompatible material.

Another preferred embodiment is a screw-type implant in which the threads are formed on the apical portion of the implant and the central portion is unthreaded and formed so that it does not impart any compression forces on the bone in which the osteotomy is formed. As in the first mentioned embodiment, the diameter of the non-threaded portion of the implant is selected to be as small as possible while providing the required strength for withstanding the dynamic loading involved in use.

Yet another preferred embodiment is a screw-type implant, as briefly described above, but formed with a helical shallow groove in the unthreaded portion of the implant to ensure that sufficient space is provided for bone healing having haversian-type microstructure.

Still another preferred embodiment of the invention is an ultra short implant, generally of a plateau type that is formed with a surface topography of sufficient size and shape to allow the formation of a blood clot around the geometry of its surface.

### BRIEF DESCRIPTION OF THE DRAWINGS

FIGS. 1 and 2 are elevational views of two screw-type implants made according to preferred embodiments of the invention;

FIG. 3 is an elevational view of another screw-type implant having helical grooves formed in the unthreaded portion of the elongated body and FIG. 3(a) is an end view of the FIG. 3 implant; and

FIG. 4 is an elevational view of an ultra short plateau-type implant made according to another preferred embodiment of the invention, and FIG. 4(a) is a perspective view of the FIG. 4 implant.

### DETAILED DESCRIPTION OF PREFERRED EMBODIMENTS

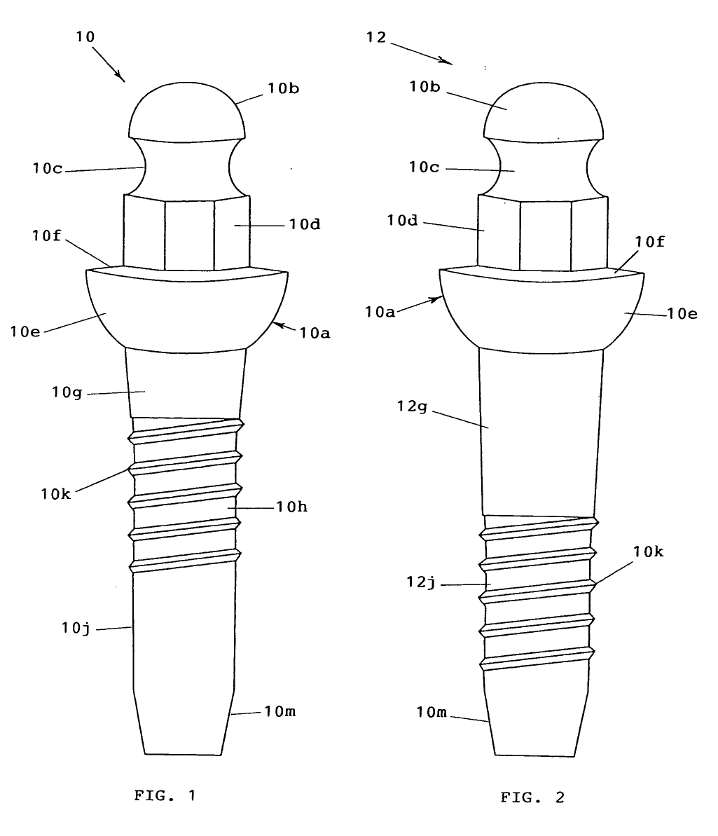

With reference to FIG. 1 of the drawings, threaded implant 10 comprises an elongated body having an integrally formed abutment portion 10a formed with a suitable head portion 10b shown to include O-ring groove 10c and polygonal shaped portion 10d for driving the implant into an osteotomy. Head portion 10b is formed with a generally semi-spherical nose portion particularly useful for mounting prosthesis having bridge structures and the like formed with O-ring snap-on features. As noted above, various other head structures can be used, as desired.

Abutment portion 10a is formed with a basal portion 10e formed with a smooth, preferably convex outer surface portion, such as a portion of a spherical configuration, ellipsoid or the like. A shelf 10f is formed at and between the junction of head portion 10b and basal portion 10e. Shelf 10f preferably forms an angle with an imaginary plane that is perpendicular to the longitudinal axis (not shown) of the head portion in the range of approximately 0 to 30 degrees, and more preferably, approximately 15 degrees, as disclosed in U.S. Pat. No. 6,290,500, assigned to the assignee of the present invention, the subject matter of which is incorporated herein by this reference.

The elongated body extending from the head portion 10a comprises a coronal axial length portion 10g, a central or middle axial length portion 10h and an elongated apical axial length portion 10j. In the FIG. 1 embodiment a cortical bone thread 10k is formed on the central axial length portion 10h.

With reference to FIG. 2, threaded implant 12 comprises the same structural features as those of FIG. 1 but is modified to locate the cortical bone threads on the apical axial length portion. The coronal and central portions are combined to provide an elongated unthreaded slightly conical body portion 12g. Both the FIGS. 1 and 2 implants are desirably formed with tapered lead-in or guide end portions 10m to facilitate placement and insertion of the implant in a prepared osteotomy.

According to the preferred embodiments of FIGS. 1 and 2, the threaded implants are designed so that the major diameter of the thread (outside diameter) 10k is larger than the osteotomy in which the implant is to be placed by an amount that will compress bone within the elastic limit of the bone and leave a compressive stress in the bone, the magnitude of which is such that remodeling is stimulated. Too much compression would lead to necrosis or even cracking, and that bone would need to be resorbed before healing could take place. The minor diameter of the thread at 10h, 12j, (the body diameter between threads or inside diameter) is enough smaller than the osteotomy so that a blood clot can form and healing of the type leading to haversian type microstructure can take place. According to a feature of the invention, the number of threads, i.e., the number of turns of the thread, are limited to only enough to provide the desired initial stability of the implant. It has been found to be preferably between 2 and 6 and more preferably 3 or 4 turns. The conical area coronal to the thread compressively seals the osteotomy and stabilizes the implant. Overdriving the implant can cause a ring of necrosis at the edge of the osteotomy, but the cone assures that the depth of necrosis is limited. The unthreaded portion of the body is small enough in diameter to allow a 100 micron gap between that portion and the wall surface of the osteotomy to allow this type of healing.

An implant made according to the invention providing the desired spacing discussed above for an osteotomy having a diameter of 2.1 mm, by way of example, has a bone thread outer diameter of 2.5 mm and an inner diameter of 1.8 mm. These dimensions provide 100 microns or more per side between the osteotomy and the inner diameter and an appropriate microstructure of the bone, that is, compression on the bone by the outer diameter of the thread. However, although the unthreaded portion may be 200 microns smaller than the osteotomy, there is a fair probability that the unthreaded portion of the body will lie closer to one portion of the wall of the osteotomy with the opposing side of the implant having more than 100 microns between it and the opposite portion of the osteotomy wall, and the closer side less than the 100 microns to that side.

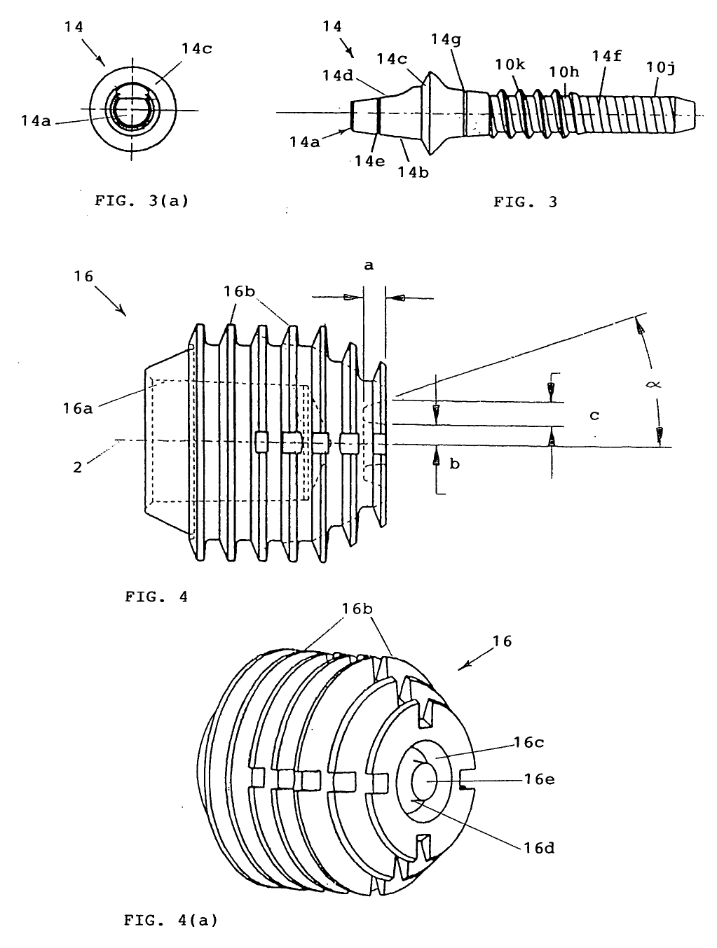

According to a modified embodiment shown in FIGS. 3, 3(a), a helical shallow groove 14f, preferably 50 to 200 microns in depth, and more preferably 100 to 150 microns in depth, are formed on the unthreaded portion of the body of implant 14 coronal to the tapered approach to the flat end of the implant. The groove provides room for a contiguous blood clot from the apex to the coronal end of the threaded portion of the implant as seen in FIG. 3. The groove may be more important in longer versions of the unthreaded body but will help to prevent voids in the bone at the apex in the shorter versions. The apical end face of the implant is preferably flat because it is too small for meaningful annular features. The end pushes against blood and bone chips in the osteotomy. The taper at the apical end guides the implant to follow the osteotomy even though lateral forces are almost certainly applied while driving the implant. Longer implants have longer unthreaded body portions between the threads and the tapered apical end. The purpose of the longer implants is to provide greater resistance to lateral forces applied to the coronal portion of the implant. The longer body is simply a longer lever arm.

Threaded implant 14 is provided with a crown receiving head 14a having a generally cylindrical tapered nose 14b projecting from shelf 14c. Nose 14b is desirably formed with one or more anti-rotation flats 14d and may be formed with a stepped locking or retention portion 14e formed intermediate to first and second axial length portions of the nose as shown and claimed in U.S. Pat. No. 6,592,370, assigned to the assignee of the present invention, the subject matter of which is incorporated herein by this reference. Also shown is an epithelial stop 14g that may be formed in the coronal portion of the elongated body as shown and claimed in U.S. Pat. No. 6,227,857, assigned to the assignee of the present invention, the subject matter of which is also incorporated herein by this reference.

With reference to FIGS. 4 and 4(a), an ultra short implant 16 is shown particularly adapted for use in the posterior region of the alveolar bone or other areas where minimal bone depths occur. Generally, implants shorter than 8 mm are considered to be short implants. Due to problems with the capability of withstanding lateral loading it has been generally considered that implants of 7 mm or less as being unworkable. However, a squat, wider than normal implant of less than 7 mm having improved lateral loading capability is disclosed and claimed in U.S. Pat. No. 6,227,857, referenced above. This patent shows an ultra short implant whose ratio of length to width is no greater than 1.5:1. The resistance to lateral loading of this implant is due, at least in part, to the generally spherical configuration of the lower part of the implant body and fins in addition to a load bearing recess or groove in the distal end face of the implant.

As in the patented implant discussed in the last paragraph, implant 16 of FIGS. 4 and 4(a) is provided with an abutment receiving bore 16a and a plurality of fin members 16b extending outwardly from the body portion of the implant in a direction generally perpendicular to longitudinal axis 2. The lower or apical portion of the implant, including the apical fins, approximate a spherical configuration for improving resistance to lateral loading with the fins providing space for haversian-type bone formation. The FIGS. 4 and 4(a) embodiment provides an additional improvement for enhancing lateral load capability by means of an annular groove 16c in the apical end face of the implant. The inner wall 16d of the groove defines a protrusion 16e and is formed so that it is generally parallel to axis 2, in essence increasing the effective length of the implant by adding to the lateral load resisting surface area of the implant in addition to providing sufficient space for haversian-type bone formation against which the inner wall 16d will react once the bone is formed.

By way of example, an implant 16 made in accordance with the invention of FIGS. 4 and 4(a) has an annular groove 16c having a depth a of 0.56 mm, a width c of 0.58 mm and an inner radius b of 0.48 mm with the outer wall of the annulus forming an angle of alpha of approximately 20 degrees.

The provision of annular groove 16c allows use a shorter implant in a given case in which the depth of the bone does not allow a longer implant that is nevertheless capable of resisting lateral loads than otherwise would be possible.

Although the invention has been described with regard to specific preferred embodiments thereof, variations and modifications will become apparent to those of ordinary skill in the art. It is therefore, the intention that the appended claims be interpreted as broadly as possible in view of the prior art to include all such variations and modifications.

What is claimed:

1: The method of promoting the formation of dense, cortical-type bone with haversian vascular systems contiguous to a newly placed implant in a living body comprising the steps of forming an osteotomy in a bone of the body, the osteotomy having a bore of a selected diameter, selecting an implant having a coronal portion, a central portion and an apical portion, each portion having a diameter, one of the apical portion and the central portion being elongated and unthreaded and having a diameter sufficiently less than the selected diameter of the osteotomy to provide at least approximately 100 microns between the said portion and the wall of the osteotomy to allow haversian-type bone formation between the said one portion and the wall of the osteotomy, the other of the apical and the central portion being adapted to engage the wall of the bone in the osteotomy to provide initial stalbility, and inserting the implant into the osteotomy with said one of the apical portion and the central portion received in the bore of the osteotomy without imparting any compression forces to the bone by the said one of the apical portion and the central portion.

2: The method according to claim 1 in which the said other of the apical and the central portions is formed with a selected number of thread turns, the threads having a diameter slightly larger than the diameter of the bore of the osteotomy.

3: The method of claim 2 in which the selected number of threads turns is between 2 and 6.

4: The method according to claim 1 in which the selected number of thread turns is 3 or 4.

5: An implant for placement in an osteotomy in the bone of a living body comprising an elongated cylindrical member formed of biocompatible material and having a coronal portion, a central portion and an apical portion, one of the central portion and the apical portion formed with bone threads having a selected outer diameter and a selected inner diameter, the other of the central portion and apical portion having a diameter sufficiently less than the selected outer diameter to allow for the formation of a blood clot in the space between the said other of the central portion and the apical portion and the surface of the osteotomy.

6: An implant according to claim 5 in which the diameter of the said other of the central portion and the apical portion has a diameter at approximately at least 700 microns less than the selected outer diameter of the said one portion formed with bone threads.

7: An implant according to claim 5 in which the said other of the central and apical portions is formed with a helical groove extending generally along its entire length, the depth of the groove being sufficient so that there is at least a gap between the bottom of the groove and the surface of the osteotomy in which the implant is placed sufficient to allow for the formation of a blood clot between the said other of the central portion and the apical portion and the surface of the osteotomy.

8: An implant according to claim 7 in which the depth of the groove is between approximately 50 and 200 microns.

9: An implant according to claim 7 in which the depth of the groove is between approximately 100 and 150 microns.

10: An implant according to claim 7 further comprising a tapered apical end of the implant to serve to guide the implant when inserted into an osteotomy, the taper located apical to the helical groove.

11: An implant having a body formed with opposed coronal and apical end faces, the coronal and apical end faces spaced apart along a longitudinal axis forming a length, the body having a width taken in a direction perpendicular to the longitudinal axis, an abutment receiving bore formed through the coronal end face and extending into the body along the longitudinal axis to a closed end, the ratio of length to width being no greater than 1.5:1, the improvement comprising an annular groove formed in the body at the apical end face defined by an inner and an outer side wall, the inner wall extending generally parallel to the longitudinal axis, the annular groove formed sufficiently large to allow the formation of haversian-type bone within the groove and the inner side wall providing improved resistance to lateral forces.

12: An implant according to claim 11 in which the depth of the annular groove is approximately 0.56 mm and the width is approximately 0.58 mm.
